(19) United States
(12) Patent Application Publication
(10) Pub. No.: US 2008/0313283 A1
(43) Pub. Date: Dec. 18, 2008

(54) METHOD AND SYSTEM FOR AUTOMATED POPULATION OF MESSAGE BODY AND ADDRESS FIELDS BASED ON EMAIL SUBJECT

(75) Inventors: David A. Cohen, Poughkeepsie, NY (US); Jayesh B. Patel, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/762,825

(22) Filed: Jun. 14, 2007

(51) Int. Cl. G06F 15/16

(52) U.S. Cl. 709/206

(57) ABSTRACT

A method for automatically populating fields included in an electronic mail (email) message, the method includes: receiving an email subject input from a composer of the email message; determining whether the received email subject input matches a previously entered subject; wherein the previously entered subject is linked with predefined data and information associated with one or more email message fields; and wherein the one or more email message fields of the email message are automatically populated with the predefined data and information in the event that the received email subject matches the previously entered subject.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates generally to computer software, and more particularly to a method and system for streamlining the writing and sending of repetitive electronic mail.

2. Description of the Related Art

Electronic mail has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

The ease of use of electronic mail (email) has led to using email for nearly any type of correspondence. Many of these correspondences are repetitive in nature, such as a meeting notification, an absence from work, a doctor's appointment, “I am running late,” etc. The writing and sending of an email involves the typing in of a subject, one or more recipients, and a message body. The typing of repetitive messages to the same recipients several times a day can become a time consuming and tedious chore. In addition, portable communication and computing devices generally have small keypad areas for entry of email content and recipient information. Therefore there is a need for streamlining the process of writing and sending repetitive emails.

### SUMMARY OF THE INVENTION

Embodiments of the present invention include a method and system for automatically populating fields included in an electronic mail (email) message, wherein the method includes: receiving an email subject input from a composer of the email message; determining whether the received email subject input matches a previously entered subject; wherein the previously entered subject is linked with predefined data and information associated with one or more email message fields; and wherein the one or more email message fields of the email message are automatically populated with the predefined data and information in the event that the received email subject matches the previously entered subject.

A system for automatically populating fields in electronic mail (email), the system includes: one or more server devices in communication with one or more client devices through a network; the server devices and the client devices configured to execute electronic software that automatically populates fields in emails; wherein the electronic software is resident on storage mediums in signal communication with the client and server devices; wherein the electronic software comprises a series of algorithms configured for: receiving an email subject; determining whether the received email subject matches a previously entered subject; wherein the previously entered subject is linked with predefined data and information; and wherein if the received email subject matches the previously entered subject, one or more fields of an email are automatically populated with the predefined data and information.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, a solution is technically achieved for a method and system for streamlining the process of writing and sending repetitive emails. The electronic mail software automates the population of message body and recipient address fields based on the email subject.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIGS. 1A-1C illustrate an electronic message that features the automatic population of the message body and recipient address fields according to an embodiment of the invention.

FIG. 2 illustrates a flow chart for the generation of an email according to an embodiment of the invention.

FIG. 3 illustrates a system for implementing embodiments of the invention.

The detailed description explains the preferred embodiments of the invention, together with advantages and features, by way of example with reference to the drawings.

### DETAILED DESCRIPTION

Embodiments of the invention provide a method and system for streamlining the process of writing and sending repetitive emails. The electronic mail software automates the population of message body and recipient address fields based on the email subject. Embodiments of the invention eliminate the need for users to write or compose the same messages on a redundant and repetitive basis, and thus save the user time and increase their productivity. In addition, embodiments of the invention offer a convenient and efficient solution for sending repetitive emails on handheld portable communication and computing devices that have small input keyboards, keypads, and display screens.

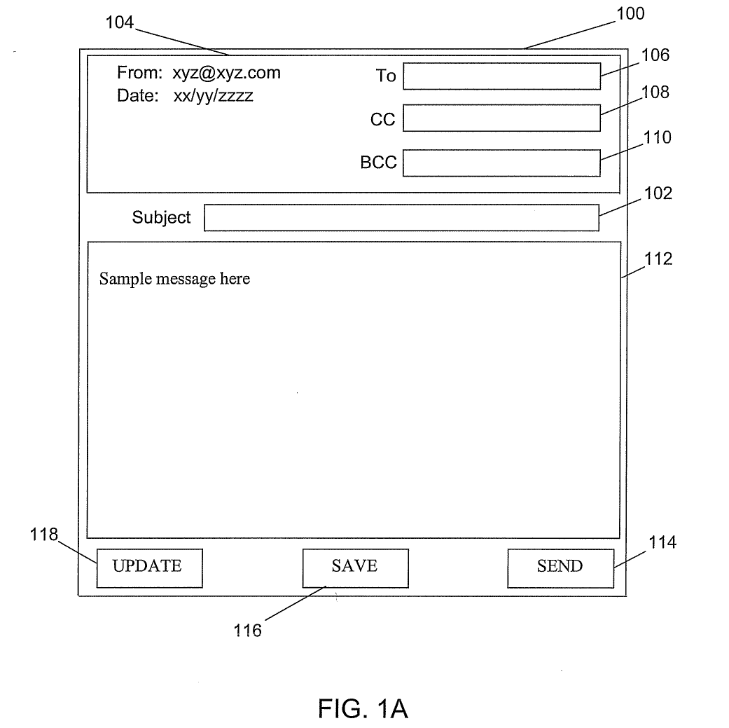

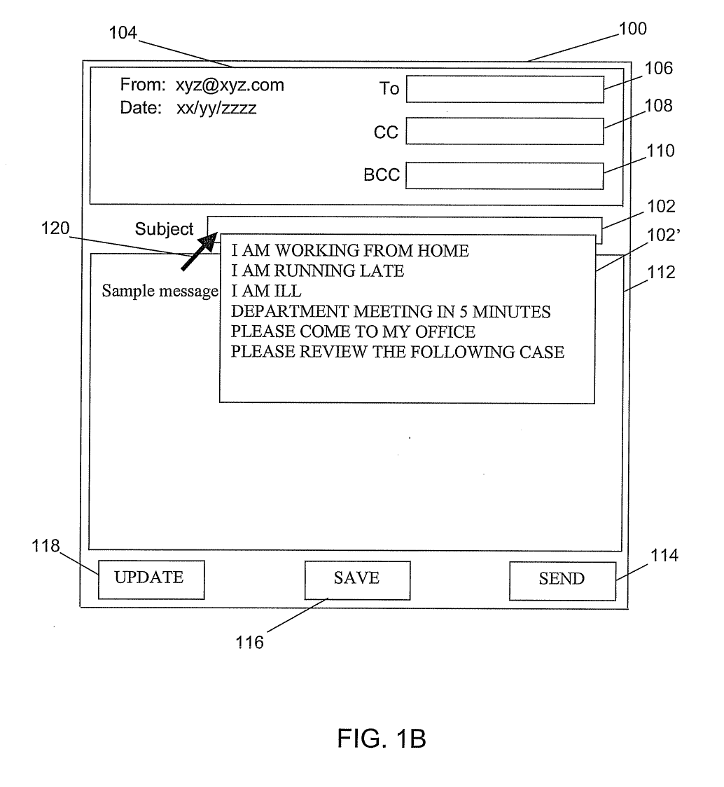

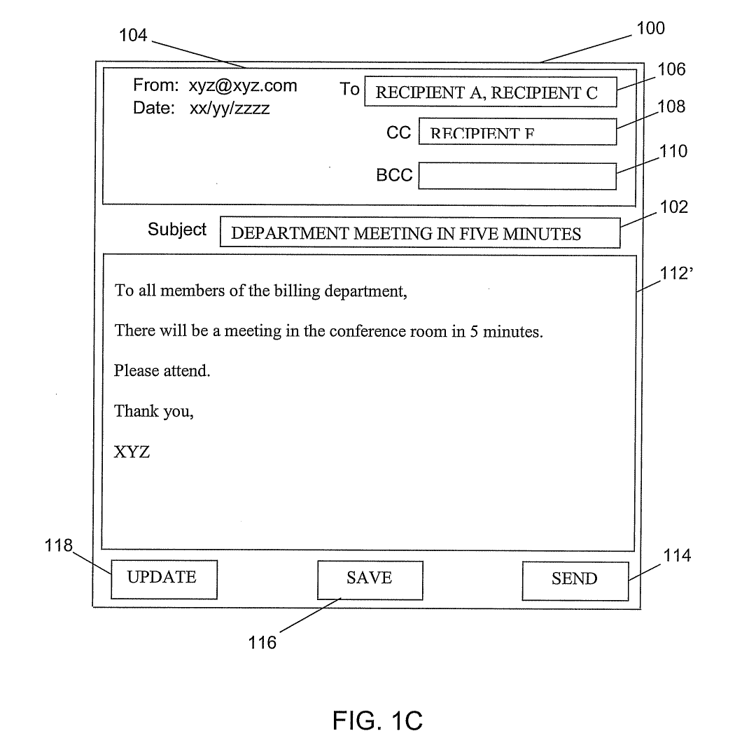

FIGS. 1A-1C illustrate an embodiment of the invention, wherein a message sender opens a graphical user interface (GUI) email template 100, and selects a subject from a menu of subject titles, for example from a drop down list box 102. The subject titles are listed in the list box 102′ of FIG. 1B, when the message sender places a cursor 120 in the area of the list box 102. In FIG. 1C, based on the subject selected, the address field 104 is automatically populated with intended recipients added to the To (106), CC (108), and BCC (110), and a corresponding relevant message is generated in the message body section 112′ of the email template 100. The only other operation the message sender is required to execute is to select send 114, and the email will be sent to the intended recipients. The selectable values in the drop down subject list 102, and their corresponding values for the address 104 and message body 112 fields may be populated by a self-learning mechanism in an email client program. The message sender is presented with an option, when entering a unique value within the subject box 102, to register the unique subject value as a new email client profile with a save key 116. A hot key, such as the update key 118 enables the message sender to update values (recipients, message body) for an existing subject to keep them current. In addition, auto completion or pattern matching of text strings can be utilized during the entry of the subject in the subject line 102.

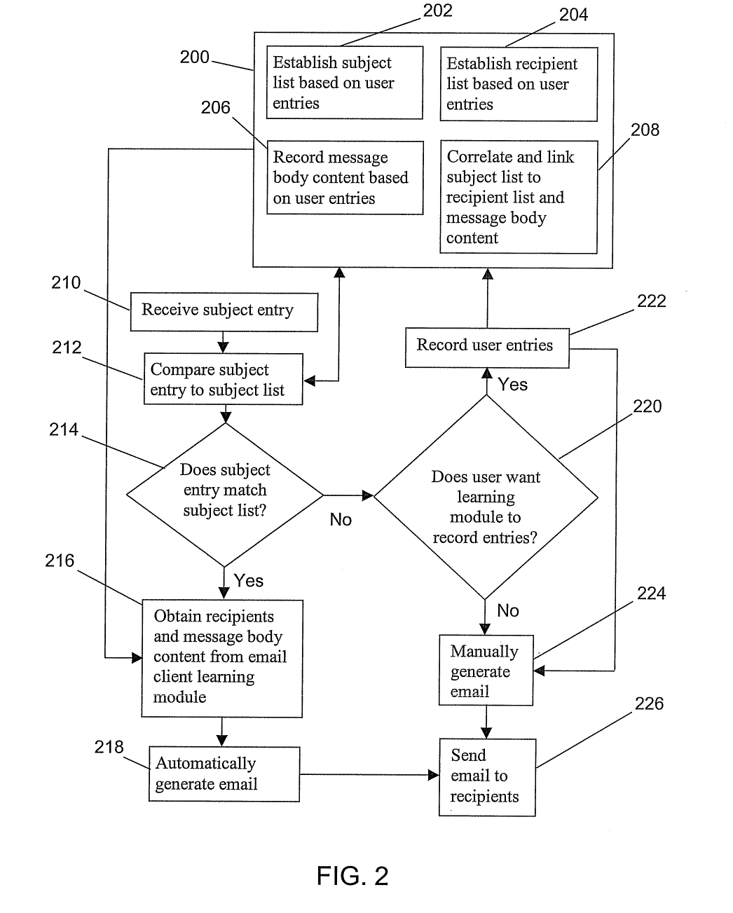

FIG. 2 is a flow diagram detailing the operation of an embodiment of the invention. An email client-learning module 200 establishes a subject list (block 202), a recipient list (block 204), and records message body content (block 206), and correlates and links (block 208) the subject list 202 to the recipient list 204 and message body content 208. Upon receiving a subject entry (block 210) the email client software compares the subject entry to the subject list (block 212) in the email client-learning module 200. If the subject entry for the email matches a subject in the subject list (block 214 is Yes), the recipients and message body content associated with the subject entry are obtained from the email client learning module (block 216 and 200), and automatically populated into the address field and message body section, respectively thereby automatically generating the email (block 218). The email is then sent to the recipients (block 226). If the subject entry for the email does not match any subject in the subject list (block 214 is No), the message sender is asked (block 220) if they want the email client-learning module 200 to record the entries (block 222) for the current email. The email is manually generated (block 224), and sent to the recipients (block 226).

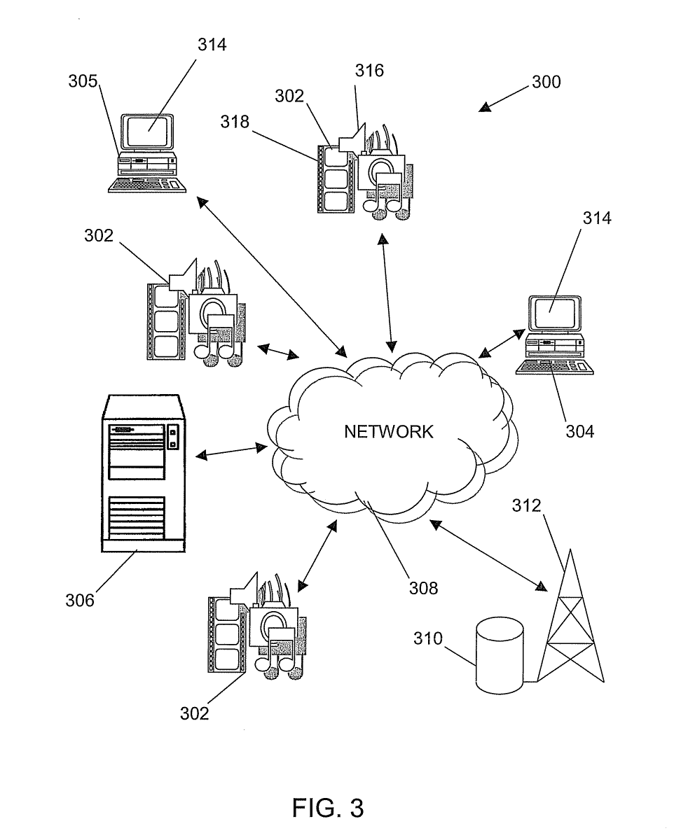

FIG. 3 is a block diagram of an exemplary system 300 for streamlining the process of writing and sending repetitive emails according to an embodiment of the invention, and graphically illustrates how these blocks interact in operation. The system 300 includes remote devices including one or more multimedia/communication devices 302 equipped with speakers 316 for implementing the audio, as well as display capabilities 318 for facilitating graphical user interface (GUI) aspects of the present invention. In addition, mobile computing devices 304 and desktop computing devices 305 equipped with displays 314 for use with the GUI of the present invention are also illustrated. The remote devices 302 and 304 may be wirelessly connected to a network 308. The network 308 may be any type of known network including a local area network (LAN), wide area network (WAN), global network (e.g., Internet), intranet, etc. with data/Internet capabilities as represented by server 306. Communication aspects of the network are represented by cellular base station 310 and antenna 312. Each remote device 302 and 304 may be implemented using a general-purpose computer executing a computer program for carrying out the GUI described herein. The computer program may be resident on a storage medium local to the remote devices 302 and 304, or maybe stored on the server system 306 or cellular base station 310. The server system 306 may belong to a public service. The remote devices 302 and 304, and desktop device 305 may be coupled to the server system 306 through multiple networks (e.g., intranet and Internet) so that not all remote devices 302, 304, and desktop device 305 are coupled to the server system 306 via the same network. The remote devices 302, 304, desktop device 305, and the server system 306 may be connected to the network 308 in a wireless fashion, and network 308 may be a wireless network. In a preferred embodiment, the network 308 is a LAN and each remote device 302, 304 and desktop device 305 executes a user interface application (e.g., web browser) to contact the server system 306 through the network 308. Alternatively, the remote devices 302 and 304 may be implemented using a device programmed primarily for accessing network 308 such as a remote client.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for automatically populating fields included in an electronic mail (email) message, wherein the method comprises:
receiving an email subject input from a composer of the email message;
determining whether the received email subject input matches a previously entered subject;
wherein the previously entered subject is linked with predefined data and information associated with one or more email message fields; and
wherein the one or more email message fields of the email message are automatically populated with the predefined data and information in the event that the received email subject matches the previously entered subject.

2. The method of claim 1, wherein the one or more email message fields comprise address fields, and message body fields.

3. The method of claim 1, wherein the previously entered subjects and the predefined data and information are learned by a self-learning mechanism in an email client program.

4. The method of claim 1, wherein the message composer can update the predefined data and information.

5. The method of claim 1, wherein the received subject input is selected from a drop down menu.

6. The method of claim 1, wherein the received subject input is generated by auto completion of alphanumeric text strings.

7. A method of automatically entering data in an email application, comprising the computer implemented steps of:
linking a set of preselected email send fields;
monitoring data entered by a user in one of the preselected email send fields; and
automatically entering data stored in a user profile into at least one other of the linked send fields in response to the step of monitoring data entered by the user.

8. The method of claim 7, wherein the one of the preselected email send fields is a subject field, the preselected email send fields comprise a To field, a CC field, and a message body field; and
wherein data is entered automatically at least in the message body field in response to monitoring data entered by the user in the subject field.

9. A system for automatically populating fields included in an electronic mail (email) message, the system comprising:
one or more server devices in communication with one or more client devices through a network;
the server devices and the client devices configured to execute electronic software that automatically populates fields in emails;
wherein the electronic software is resident on storage mediums in signal communication with the client and server devices;
wherein the electronic software comprises a series of algorithms configured for:
receiving an email subject input from a composer of the email message;
determining whether the received email subject input matches a previously entered subject;
wherein the previously entered subject is linked with predefined data and information associated with one or more email message fields; and
wherein the one or more email message fields of the email message are automatically populated with the predefined data and information in the event that the received email subject matches the previously entered subject.

10. The system of claim 9, wherein the one or more email message fields comprise address fields, and message body fields.

11. The system of claim 9, wherein the previously entered subjects and the predefined data and information are learned by a self-learning mechanism of the electronic software.

12. The system of claim 9, wherein the message composer can update the predefined data and information.

13. The system of claim 9, wherein the received subject input is selected from a drop down menu.

14. The system of claim 9, wherein the received subject input is generated by auto completion of alphanumeric text strings.
